(19) United States
(12) Patent Application Publication
(10) Pub. No.: US 2025/0076887 A1
(43) Pub. Date: Mar. 6, 2025

(54) INFORMATION PROCESSING DEVICE, SPACE MANAGEMENT SYSTEM AND INFORMATION PROCESSING METHOD

(71) Applicant: Mitsubishi Electric Corporation, Tokyo (JP)

(72) Inventors: Misato WATANABE, Tokyo (JP); Miki ARAI, Tokyo (JP); Takayasu HASHIMOTO, Tokyo (JP); Yuri KUBOTA, Tokyo (JP); Dongsuk PARK, Tokyo (JP)

(73) Assignee: Mitsubishi Electric Corporation, Tokyo (JP)

(21) Appl. No.: 18/951,704

(22) Filed: Nov. 19, 2024

Related U.S. Application Data
(63) Continuation of application No. PCT/JP2022/025637, filed on Jun. 28, 2022.

(51) Int. Cl. G05D 1/43; G06Q 10/02; G06Q 50/40; G08G 1/005

(52) U.S. Cl. CPC G05D 1/43; G06Q 10/02; G06Q 50/40; G08G 1/005

(57) ABSTRACT

An information processing device includes processing circuitry configured to; acquire target area information indicating a situation of a target area, use schedule information indicating a use schedule of a mobile body by a user in the target area, and space reservation information indicating a use reservation of a space in the target area; determine a use mode of the space for the mobile body depending on convenience of the user in the target area on a basis of the target area information and the use schedule information; and update the space reservation information on a basis of the determined use mode.

### CROSS-REFERENCE TO RELATED APPLICATIONS

This application is a Continuation of International Patent Application No. PCT/JP2022/025637, filed on Jun. 28, 2022, the entire contents of which are incorporated herein by reference.

### TECHNICAL FIELD

The present disclosure relates to an information processing device, a space management system, and an information processing method.

### BACKGROUND ART

A technique that supports boarding of a user on a service vehicle that provides a passenger service, such as a taxi or a bus has been proposed. For example, Patent Literature 1 discloses a boarding position selecting system that selects, as a boarding position, a position easily accessible from a vicinity of a current position of a user or a boarding request position.

### CITATION LIST

### Patent Literature

Patent Literature 1: JP H10-208195 A

### SUMMARY OF INVENTION

### Technical Problem

Conventionally, a boarding space for a taxi, a bus, or the like is fixedly located, and therefore there is a problem that convenience of a user may be impaired. For example, in a case where a taxi boarding space is located at a position far from a ticket gate of a station, there is a possibility that a user cannot find the taxi boarding space immediately.

By the way, in a conventional technique disclosed in Patent Literature 1, a boarding space is not selected as a boarding position unless the boarding space is near a current position of a user or a boarding request position.

The present disclosure solves the above problem, and an object of the present disclosure is to obtain an information processing device, a space management system, and an information processing method capable of providing a use space of a mobile body in consideration of convenience of a user.

### Solution to Problem

An information processing device according to the present disclosure includes: processing circuitry configured to: acquire target area information indicating a situation of a target area, use schedule information indicating a use schedule of a mobile body by a user in the target area, and space reservation information indicating a use reservation of a space in the target area; determine a use mode of the space for the mobile body depending on convenience of the user in the target area on a basis of the target area information and the use schedule information; and update the space reservation information on a basis of the determined use mode; determine whether or not it is necessary to newly add a space where the user transfers from the mobile body to another mobile body in the target area, using the use schedule information and the space reservation information; and when determining that it is necessary to newly add the space, determine a transfer mode of the mobile body depending on the convenience of the user, define the determined transfer mode as a new use mode, and calculate a space requirement necessary for the transfer mode.

### Advantageous Effects of Invention

According to the present disclosure, the target area information, the use schedule information, and the space reservation information are acquired, a use mode depending on convenience of a user is determined on the basis of the target area information and the use schedule information, and the space reservation information is updated on the basis of the determined use mode. Since the space reservation information is updated in a use mode depending on the convenience of the user, the information processing device according to the present disclosure can provide a use space of a mobile body in consideration of the convenience of the user.

### BRIEF DESCRIPTION OF DRAWINGS

FIG. 1 is a block diagram illustrating a configuration of a space management system according to a first embodiment.

FIG. 2 is a block diagram illustrating a hardware configuration for implementing a function of an information processing device according to the first embodiment.

FIG. 3 is a diagram illustrating an example of a target area for space management.

FIG. 4 is a flowchart illustrating map data update processing.

FIG. 5 is a flowchart illustrating space management processing of a target area.

FIGS. 6A, 6B, 6C, 6D, and 6E are diagrams illustrating various use modes of a vehicle.

FIG. 7 is a diagram illustrating a dynamic map of a target area reflecting a use space of a vehicle.

FIG. 8 is a flowchart illustrating vehicle control processing based on space reservation information.

FIG. 9 is a diagram illustrating a dynamic map of a target area when an example (1) of vehicle control processing is performed.

FIG. 10 is a diagram illustrating a dynamic map of a target area when an example (2) of vehicle control processing is performed.

FIG. 11 is a flowchart illustrating display processing based on space reservation information.

FIG. 12 is a diagram illustrating a dynamic map of a target area reflecting a monitoring area in which entry of a vehicle into a reserved space is monitored.

FIG. 13 is a diagram illustrating an example (1) of a display mode in which entry of a vehicle into a reserved space is prohibited.

FIG. 14 is a diagram illustrating an example (2) of a display mode in which entry of a vehicle into a reserved space is prohibited.

FIG. 15 is a flowchart illustrating space allocation change processing in a target area.

FIG. 16 is a diagram illustrating a dynamic map of a target area.

FIG. 17 is a diagram illustrating a dynamic map of a target area in which space allocation has been changed.

### DESCRIPTION OF EMBODIMENTS

### First Embodiment

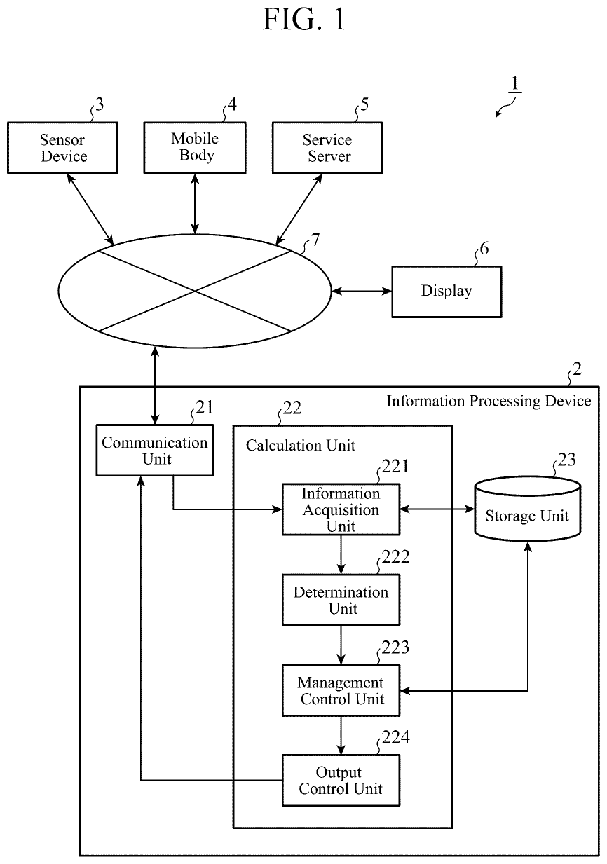

FIG. 1 is a block diagram illustrating a configuration of a space management system 1 according to a first embodiment. In FIG. 1, the space management system 1 is a system in which an information processing device 2, a sensor device 3, a mobile body 4, a service server 5, and a display 6 are connected to each other via a network 7. The network 7 is an electric communication line including the Internet.

The space management system 1 includes at least the information processing device 2 and the sensor device 3, and provides a space management service that updates space reservation information on the basis of a use mode depending on convenience of a user. A target area is an area where a user frequently uses a vehicle, and is, for example, a rotary in front of a station, a commercial resort parking lot directly connected to an interchange, a service area parking lot, or a large shopping mall parking lot.

The information processing device 2 acquires target area information, use schedule information, and space reservation information, determines a use mode depending on convenience of a user on the basis of the target area information and the use schedule information, and updates the space reservation information on the basis of the determined use mode. The target area information includes static information, semi-static information, semi-dynamic information, and dynamic information.

The static information is information indicating a static situation of a target area, and is, for example, road surface information, road information, or building information in units of a year or in units of a month. The semi-static information is information indicating a future situation of the target area, and is, for example, information regarding an event using the target area in the future in units of an hour or weather information of the target area.

The semi-dynamic information is information indicating a situation of the target area in a nearer future than the semi-static information, and is, for example, information regarding an event using the target area in the future in units of a minute or weather information of the target area. The dynamic information is information indicating a dynamic situation of the target area, and is, for example, information indicating a moving state of an object present in the target area. For example, the dynamic information is information indicating a moving state of an object detected in units of a second.

The information processing device 2 can recognize current and future states of the target area using the static information, the semi-static information, the semi-dynamic information, and the dynamic information for the target area. As a result, the space management system 1 can perform space management depending on the current and future states of the target area.

The use schedule information is information indicating a use schedule of a mobile body by a user in the target area, and includes, for example, use content information, mobile body attribute information, and user attribute information.

The use content information is information indicating a use content of the mobile body 4, and includes, for example, information such as when and which user uses which mobile body 4 and the position of the mobile body 4 when the user uses the mobile body 4. The use of the mobile body 4 includes, for example, transfer of the mobile body 4 in which a user who has used a railway transfers to a taxi.

In addition, examples of transfer of a mobile body include transfer from a bus to a bus, transfer from a taxi to a bus, transfer from a personal mobility vehicle (hereinafter, referred to as PMV) to a bus, and transfer from walking to a bus. Furthermore, transfer from a bus to a plurality of mobile bodies such as a taxi, a train, and a PMV is also included.

The mobile body attribute information is information indicating an attribute of the mobile body 4 to be used, and includes, for example, information such as a size, a traveling characteristic, a getting-on and getting-off characteristic, and a cabin situation (in-vehicle situation) of the mobile body 4 to be used. The information indicating the getting-on and getting-off characteristic includes, for example, information indicating the position and height of an entrance of the mobile body 4, and also includes information indicating whether or not the mobile body 4 includes getting-on and getting-off equipment (slope or the like). The space management system 1 can determine a use mode that can be used by the mobile body 4 by using the mobile body attribute information.

The user attribute information is information indicating an attribute of a user who uses the mobile body 4, and includes, for example, in addition to identification information of the user, information indicating a moving means (walking, a wheelchair, another mobile body, or the like) of the user to the mobile body 4 to be used, information indicating whether or not a white cane is used, and information indicating whether or not a stroller or a large baggage is carried. The space management system 1 can determine convenience of the user when the user uses the mobile body 4 by using the user attribute information.

The information processing device 2 can recognize an attribute of the mobile body 4 and a state of a user at the time of using the mobile body 4 in addition to a specific method in which the user uses the mobile body 4 by using the use content information, the mobile body attribute information, and the user attribute information. As a result, the space management system 1 can determine a use mode of the mobile body 4 depending on convenience of the user, and can perform space management depending on the determined use mode.

The space reservation information is information indicating a use reservation of a space in the target area. For example, the space reservation information includes information indicating an hourly use reservation of at least one of a road space where the mobile body 4 travels, a use space where a user uses the mobile body 4, an event space, and a sidewalk space where a pedestrian moves in the target area. For example, when the user reserves use of the mobile body 4 with respect to the service server 5, the service server 5 notifies the information processing device 2 that use of the mobile body 4 has been reserved. The information processing device 2 determines a vacant space at the use schedule time as a use space of the mobile body 4, and generates space reservation information indicating that use of the space has been reserved.

By generating the space reservation information indicating an hourly use reservation of at least one of the road space where the mobile body 4 travels, the use space where the user uses the mobile body 4, the event space, and the sidewalk space where a pedestrian moves in the target area, the information processing device 2 can allocate a space of the target area to various uses in addition to the use of the mobile body 4 by the user.

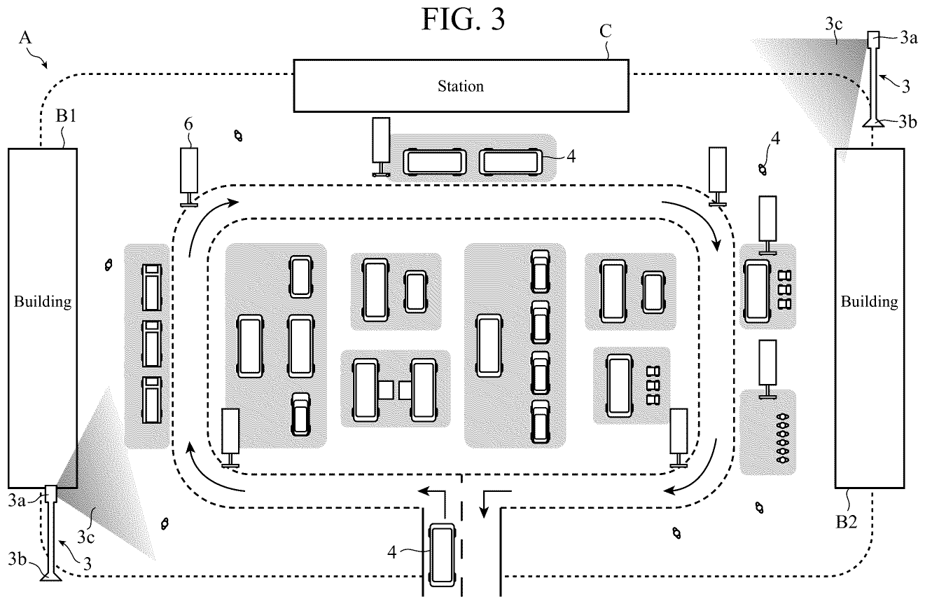

The sensor device 3 detects an object present in the target area. For example, as described later with reference to FIG. 3, the sensor device 3 includes a pole erected in the target area and a sensor unit disposed at a top portion of the pole. The sensor unit disposed in the pole can detect an object from a position where the target area is overlooked. In a case where the target area is a substantially rectangular area when viewed from above, the sensor device 3 is disposed, for example, at each diagonal position of the rectangle. As a result, the sensor device 3 can include substantially the entire target area within a detection range, and the space management system 1 can recognize a state of an object present in the entire target area using the detection information obtained by overlooking the target area.

The sensor device 3 includes a communication device capable of communicating with the information processing device 2 via the network 7. As the communication device, for example, a wireless communication device that performs intelligent transport system (hereinafter, referred to as ITS) communication can be used. The ITS communication is, for example, wireless communication in a 700 MHz band or a 5.8 GHz band. In addition, the sensor device 3 only needs to be a sensor capable of detecting an object present in the target area, and for example, a monitoring camera, a LiDAR, or a radar is used. The information processing device 2 acquires detection information of the sensor device 3 as target area information (for example, the dynamic information).

The mobile body 4 is a mobile body used by a user, and is a vehicle that provides a passenger service, such as a taxi or a bus. The mobile body 4 may be a mobile selling vehicle that provides a user with a face-to-face retail service. In addition, the mobile body 4 is a self-driving vehicle including a vehicle control unit that autonomously controls driving of the vehicle, and the vehicle is automatically operated by the vehicle control unit. Furthermore, the mobile body 4 includes a communication device capable of communicating with the information processing device 2 via the network 7. For example, the mobile body 4 receives mobile body control information from the information processing device 2 via the network 7 using the communication device, and autonomously performs a driving operation in accordance with the received mobile body control information.

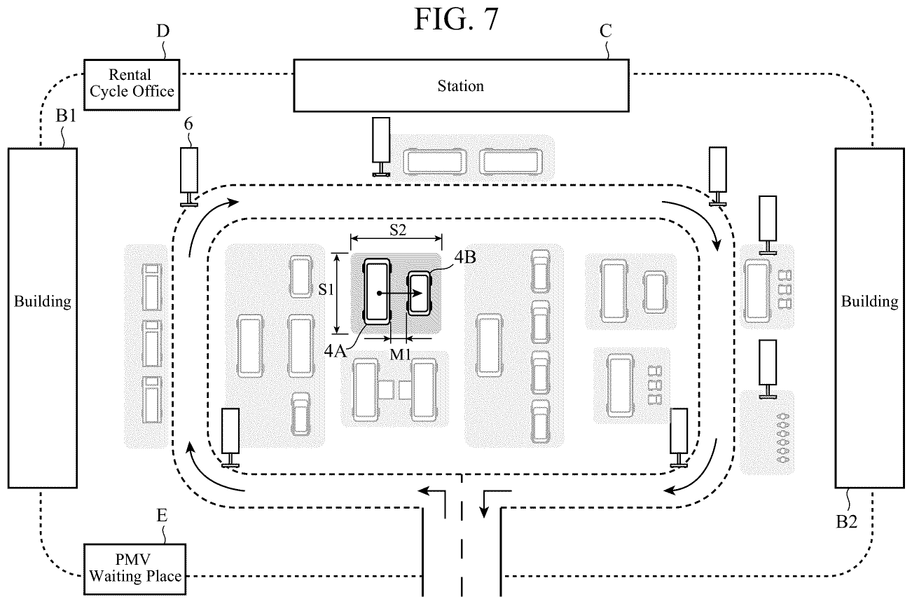

The mobile body 4 includes a display that performs display for an occupant or a display that performs display for the outside. In addition, the mobile body 4 includes a display control unit that controls a display operation of the display. For example, the mobile body 4 receives display control information from the information processing device 2 via the network 7 using the communication device, and the display control unit causes the display to display a content according to the display control information. For example, a dynamic map of the target area described later with reference to FIG. 7 may be displayed on the display that performs display for the occupant.

The mobile body 4 may include a sensor that detects an object present in the target area. For example, when the mobile body 4 is a vehicle, the vehicle includes at least one of a vehicle exterior monitoring sensor that monitors the outside of the vehicle, a vehicle interior monitoring sensor that monitors the inside of the vehicle, and a positioning sensor that measures the position of the vehicle. The information processing device 2 acquires detection information of the sensor included in the mobile body 4 as target area information (for example, the dynamic information).

The service server 5 is a server that provides a Web site of a service using the mobile body 4 via the network 7. For example, the service server 5 provides mobility as a service (MaaS) that manages operation of a railway, a bus, a taxi, a PMV, or the like. More specifically, the service server 5 provides a passenger service using a taxi or a bus.

By a user accessing the service server 5 using a terminal (not illustrated in FIG. 1) and requesting provision of a service, the service server 5 generates use content information and mobile body attribute information. Furthermore, when providing the service, the service server 5 generates user attribute information on the basis of user information set by the user. The service server 5 generates use schedule information including the use content information, the mobile body attribute information, and the user attribute information, and registers the generated use schedule information in a use schedule information database (not illustrated in FIG. 1).

The service server 5 is at least one of a server including information created by an organization or an individual and a server that provides public information. The information processing device 2 acquires the use schedule information from the use schedule information database included in the service server 5 via the network 7.

In addition, the service server 5 acquires event holding information in the target area, and generates target area information (semi-static information or semi-dynamic information) on the basis of the event holding information. The information processing device 2 acquires the semi-static information or the semi-dynamic information from the service server 5.

The display 6 displays information on the basis of the display control information. The display 6 includes a communication device capable of communicating with the information processing device 2 via the network 7. The display 6 receives the display control information from the information processing device 2 via the network 7 using the communication device. The display 6 displays a content indicated by the display control information received from the information processing device 2 on a screen. For example, the display 6 may be a roadside display disposed on a roadside in the target area, an in-vehicle display that performs display for the outside of the mobile body 4, or an on-board display.

For example, the display 6 is a liquid crystal display (LCD) or an organic electroluminescence (EL) display device.

As illustrated in FIG. 1, the information processing device 2 includes a communication unit 21, a calculation unit 22, and a storage unit 23. The communication unit 21 communicates with the sensor device 3, the mobile body 4, the service server 5, or the display 6 via the network 7. For example, the communication unit 21 is a communication device capable of mobile communication by a communication system such as LTE, 3G, 4G, or 5G, and communicates with another piece of equipment such as the sensor device 3, the mobile body 4, the service server 5, or the display 6 connected to the network 7.

The calculation unit 22 controls the overall operation of the information processing device 2. The calculation unit 22 implements various functions by executing an information processing application for updating the space reservation information of the target area in a space management service. The storage unit 23 stores an information processing application and information used for calculation processing by the calculation unit 22. For example, the storage unit 23 stores the target area information, the use schedule information, and the space reservation information. In addition, the storage unit 23 stores a map database in which a dynamic map of the target area is registered.

The calculation unit 22 includes an information acquisition unit 221, a determination unit 222, a management control unit 223, and an output control unit 224. By the calculation unit 22 executing the information processing application, functions of the information acquisition unit 221, the determination unit 222, the management control unit 223, and the output control unit 224 are implemented.

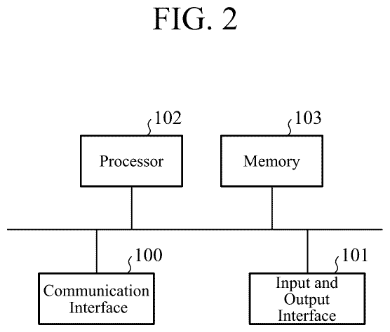

FIG. 2 is a block diagram illustrating a hardware configuration for implementing a function of the information processing device 2. For example, the information processing device 2 includes a communication interface 100, an input and output interface 101, a processor 102, and a memory 103 as a hardware configuration. The functions of the information acquisition unit 221, the determination unit 222, the management control unit 223, and the output control unit 224 included in the information processing device 2 are implemented by these components of the hardware configuration.

The communication interface 100 outputs data received from an external device via the network 7 to the processor 102, and transmits data generated by the processor 102 to the mobile body 4 or the display 6 via the network 7. The processor 102 reads and writes data from and to the storage unit 23 via the input and output interface 101. The storage unit 23 is implemented by a storage device accessible by a computer that functions as the information processing device 2.

Note that, although the information processing device 2 includes the storage unit 23 in FIG. 1, the storage unit 23 only needs to be a storage device accessible by a computer that functions as the information processing device 2, and may be present outside the information processing device 2.

An information processing application program for implementing the functions of the information acquisition unit 221, the determination unit 222, the management control unit 223, and the output control unit 224 is stored in the storage unit 23. The processor 102 reads the information processing application program stored in the storage unit 23 via the input and output interface 101, loads the program into the memory 103, and executes the program loaded into the memory 103. As a result, the processor 102 implements the functions of the information acquisition unit 221, the determination unit 222, the management control unit 223, and the output control unit 224. The memory 103 is, for example, a random access memory (RAM).

The information acquisition unit 221 acquires the target area information, the use schedule information, and the space reservation information. For example, the information acquisition unit 221 acquires the target area information from the sensor device 3 via the network 7 using the communication unit 21, acquires the use schedule information from the service server 5, and acquires the space reservation information generated using the use schedule information.

In addition, the information acquisition unit 221 may acquire only original information from external equipment, and may generate the target area information, the use schedule information, and the space reservation information using the original information.

The determination unit 222 determines a use mode depending on convenience of a user on the basis of the target area information and the use schedule information. For example, in a case where a user who has moved by a taxi has a use schedule to transfer to a bus, when it is recognized from the target area information and the use schedule information that weather around the target area is rainy and the user carries a large baggage, the determination unit 222 determines that the shorter a walking distance of the user until the user transfers to the bus, the more convenient. In this case, for example, the determination unit 222 determines that a use mode in which a taxi that the user has boarded is stopped alongside a transfer target bus is a use mode having good convenience of a user. Information indicating the use mode determined by the determination unit 222 is output to the management control unit 223.

The management control unit 223 updates the space reservation information on the basis of the use mode determined by the determination unit 222. For example, in a case where the use mode of the determination result by the determination unit 222 is the use mode in which the taxi is stopped alongside the bus, the management control unit 223 searches for a space having an area in which the taxi and the bus arranged side by side are accommodated from among spaces that have not been reserved in the target area using the space reservation information, and updates the space reservation information in such a manner that the user transfers from the taxi to the bus in the use space that has been found by the search. The space reservation information updated by the management control unit 223 is stored in the storage unit 23. The management control unit 223 reads the space reservation information from the storage unit 23 and outputs the space reservation information to the output control unit 224. Note that the space reservation information may include information indicating a route from an entrance of the target area to the use space that has been found by the search.

In addition, the management control unit 223 may generate a dynamic map reflecting a use mode depending on convenience of a user. For example, the management control unit 223 describes, on a dynamic map of the target area generated by the determination unit 222, the use space of the use mode in which the taxi is stopped alongside the bus as described above. Such a dynamic map reflecting the use mode as described above is output by the output control unit 224 in such a manner as to be displayable on the mobile body 4 and the display 6. By referring to the dynamic map, it is possible to recognize a use space in which the user uses the mobile body 4.

The output control unit 224 generates mobile body control information for controlling movement of the mobile body 4 in the target area on the basis of the updated space reservation information, and outputs the generated mobile body control information to the mobile body 4. For example, when recognizing a route to the use space from the space reservation information, the output control unit 224 generates mobile body control information for moving the mobile body 4 along this route, and transmits the mobile body control information to the mobile body 4 via the network 7 using the communication unit 21. When receiving the mobile body control information from the information processing device 2 via the network 7, the mobile body 4 autonomously moves to the use space along the route indicated by the mobile body control information.

In addition, the mobile body control information may include control information of equipment used when the user gets on and off the mobile body 4 in addition to the information for moving the mobile body 4 along a route to the use space. For example, the equipment used when the user gets on and off the mobile body 4 is getting-on and getting-off equipment such as a slope or a step. For example, when recognizing whether or not the mobile body 4 to be used has the getting-on and getting-off equipment from the mobile body attribute information, the determination unit 222 determines a use mode using the getting-on and getting-off equipment. The management control unit 223 updates the space reservation information in the use mode using the getting-on and getting-off equipment, and the output control unit 224 generates control information for activating the getting-on and getting-off equipment when the user gets on and off the mobile body 4, and adds the generated control information to the mobile body control information. As a result, the getting-on and getting-off equipment can be used when the user gets on and off the mobile body 4.

In addition, the output control unit 224 generates display control information for displaying movement of the mobile body 4 in the target area on the basis of the updated space reservation information, and outputs the generated display control information to the display 6. For example, the output control unit 224 transmits display control information for displaying a dynamic map reflecting a route to the use space that has been found by the search of the management control unit 223 to the mobile body 4 via the network 7 using the communication unit 21. In the mobile body 4, the dynamic map is displayed on the display, and an occupant of the mobile body 4 can recognize that the mobile body 4 is moving to the use space by referring to the dynamic map.

Furthermore, a navigation device included in mobile body 4 may guide the mobile body 4 to the use space using the dynamic map.

FIG. 3 is a diagram illustrating an example of a target area for space management, and illustrates a state in which a rotary in front of a station which is a target area A is overviewed from above. In the target area A, a building B1 and a building B2 are disposed at positions facing each other, and a rotary is located between the building B1 and the building B2 and in front of a station C. In addition, as illustrated in FIG. 3, the target area A is a substantially rectangular area as viewed from above, and the sensor devices 3 are disposed at diagonal positions of the rectangle.

The sensor device 3 includes a pole 3b erected in the target area A and a sensor unit 3a that is disposed at a top portion of the pole 3b and detects the mobile body 4 in the target area A. The sensor devices 3 disposed at the diagonal positions of the target area A can accommodate substantially the entire target area A in a detection range 3c. The rotary has a road space in which a vehicle that is the mobile body 4 can travel in a direction indicated by an arrow in FIG. 3. A getting-on and getting-off space of the mobile body 4 is located along the road space. The display 6 is a display that functions as a signage, and is disposed near the road space.

Note that the determination unit 222 may generate a dynamic map of the target area A, and the management control unit 223 may generate a dynamic map reflecting the updated space reservation information.

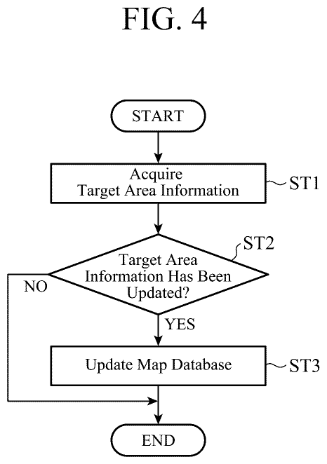

FIG. 4 is a flowchart illustrating map data update processing, and illustrates processing of updating the dynamic map of the target area A. The information acquisition unit 221 sequentially acquires target area information for the target area A (step ST1). The target area information includes, for example, static information, semi-static information, semi-dynamic information, and dynamic information for the The determination unit 222 determine whether or not the target area information of the target area A has been updated, that is, whether or not a state of an object present in the target area A has changed using the static information, the semi-static information, the semi-dynamic information, and the dynamic information sequentially acquired by the information acquisition unit 221 (step ST2). When determining that the target area information has not been updated (step ST2; NO), the determination unit 222 ends the processing. Thereafter, the information acquisition unit 221 continues the processing of step ST1, and a series of processing illustrated in FIG. 4 is repeated.

When determining that the target area information has been updated (step ST2; YES), the determination unit 222 reflects a change in the target area information on the dynamic map of the target area A in the map database stored in the storage unit 23 and updates the map database (step ST3). For example, even if the mobile body 4 in the target area A moves in units of several seconds, every position of the moving mobile body 4 is reflected on the dynamic map. Hereinafter, map data acquired from the map database is data indicating the dynamic map of the target area A. The dynamic map is updated every time a state of an object present in the target area A changes.

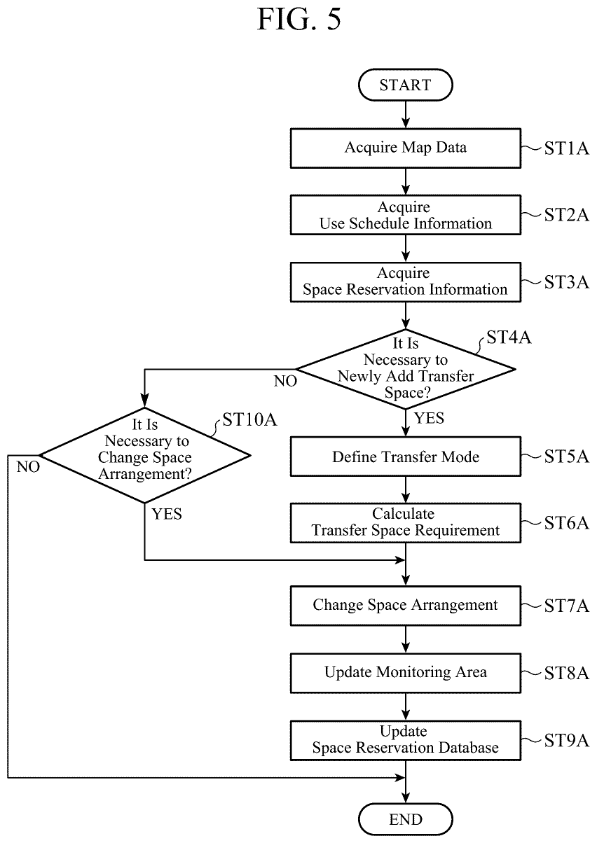

FIG. 5 is a flowchart illustrating space management processing of a target area. Hereinafter, a use mode in which a user transfers from a mobile body 4 to another mobile body 4 will be described.

The information acquisition unit 221 acquires map data (dynamic map of the target area) from the storage unit 23 (step ST1A). In addition, the information acquisition unit 221 acquires use schedule information from the service server 5 via the network 7 using the communication unit 21 (step ST2A). Furthermore, the information acquisition unit 221 acquires space reservation information of the user in the target area A from the storage unit 23 (step ST3A). Note that the case where the information acquisition unit 221 acquires the map data, the use schedule information, and the space reservation information in this order has been described, but this order may be changed, or these may be acquired simultaneously.

The determination unit 222 determines whether or not it is necessary to newly add a space where the user transfers from a mobile body 4 to another mobile body 4 in the target area A using the use schedule information and the space reservation information (step ST4A). For example, when new use of transferring from a mobile body 4 to another mobile body 4 is scheduled in the use schedule information, the determination unit 222 determines that it is necessary to add the transfer space to a space reservation of the target area A (step ST4A; YES), and determines a transfer mode of the mobile body 4 depending on convenience of the user for the newly added transfer of the mobile body 4. The determination unit 222 defines the determined transfer mode as a new use mode (step ST5A).

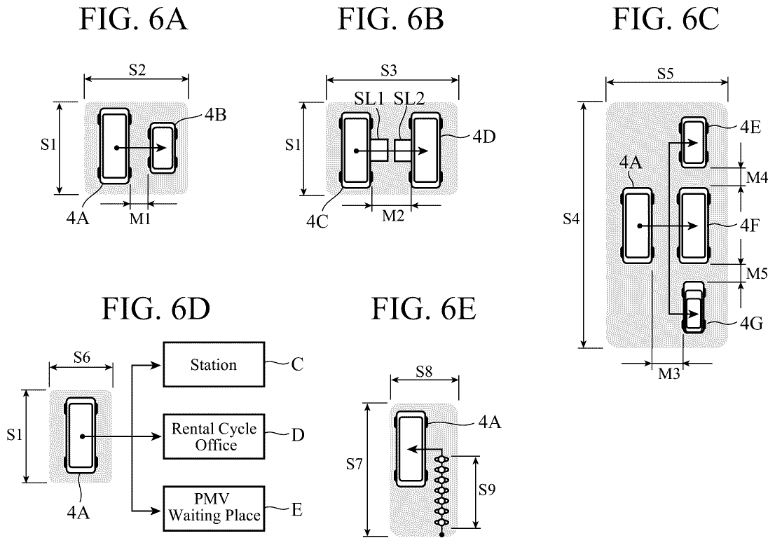

FIGS. 6A, 6B, 6C, 6D, and 6E are diagrams illustrating various use modes of vehicles 4A to 4G which are the mobile bodies 4. The determination unit 222 determines transfer modes of the vehicles 4A to 4G using the use schedule information and the space reservation information. For example, it is assumed that the determination unit 222 determines that a user is scheduled to transfer from a vehicle to another vehicle using the use schedule information, and determines that convenience of the user is better as a distance the user moves before transferring from a vehicle to another vehicle is shorter. In this case, as illustrated in FIGS. 6A and 6B, the determination unit 222 defines a transfer mode in which a vehicle 4A or 4C as a transfer source is stopped alongside (disposed in parallel with) a vehicle 4B or 4D as a transfer destination.

In addition, it is assumed that the determination unit 222 determines that a plurality of users are scheduled to transfer from a common vehicle to respective ones of a plurality of vehicles, using the use schedule information, and determines that convenience is better as a distance each of the users moves before transferring from the common vehicle to another vehicle is shorter. In this case, as illustrated in FIG. 6C, the determination unit 222 defines a transfer mode in which a vehicle 4A as a transfer source is stopped near vehicles 4E, 4F, and 4G as transfer destinations.

It is assumed that the determination unit 222 determines that a plurality of users are scheduled to move from a common vehicle to respective ones of a plurality of bases (for example, a station, a rental cycle office, and a PMV waiting place), using the use schedule information, and determines that convenience is better as a distance each of the users moves before transferring from the common vehicle to another vehicle is shorter. In this case, as illustrated in FIG. 6D, a transfer mode is defined in which a vehicle 4A as a transfer source is stopped at a point where a distance from each of the station, the rental cycle office, and the PMV waiting place is the shortest.

It is assumed that the determination unit 222 determines that a plurality of users are scheduled to get on a vehicle (for example, a taxi) using the use schedule information, and determines that convenience is better as a waiting line of the plurality of users who are about to get on the vehicle 4A is shorter. In this case, as illustrated in FIG. 6E, a transfer mode is defined in which the vehicle 4A is stopped at a point where the length of the waiting line of the users is the shortest.

When a transfer mode is defined by the determination unit 222, the management control unit 223 calculates a space requirement necessary for the transfer mode (step ST6A). For example, the management control unit 223 calculates the size of a transfer target vehicle, a positional relationship between vehicles, a positional relationship between a vehicle and a building, or the size of a parking space on the basis of the mobile body attribute information included in the use schedule information. In addition, the management control unit 223 determines necessity of getting-on and getting-off equipment such as a slope or a step on the basis of the mobile body attribute information and the user attribute information. Furthermore, the management control unit 223 determines whether or not a waiting line is generated on the basis of the user attribute information included in the use schedule information, and in a case where the waiting line is generated, the management control unit 223 checks the number of users waiting, and determines the size of a waiting space depending on the expected length of the waiting line.

For example, as illustrated in FIG. 6A, in a case where a transfer mode is defined in which a vehicle 4A as a transfer source is stopped alongside a vehicle 4B as a transfer destination, the management control unit 223 determines an interval M1 between the vehicle 4A and the vehicle 4B for transfer from the vehicle 4A to the vehicle 4B on the basis of the mobile body attribute information. Furthermore, the management control unit 223 calculates a space determined by a vertical length S1×a horizontal length S2 as a transfer space necessary for transfer from the vehicle 4A to the vehicle 4B on the basis of each of the sizes of the vehicle 4A and the vehicle 4B.

As illustrated in FIG. 6B, in a case where a transfer mode is defined in which a vehicle 4C as a transfer source is stopped alongside a vehicle 4D as a transfer destination and a slope SL1 of the vehicle 4C and a slope SL2 of the vehicle 4D are used, the management control unit 223 determines an interval M2 between the vehicle 4C and the vehicle 4D necessary for transfer on the basis of the mobile body attribute information. Next, the management control unit 223 calculates a space determined by a vertical length S1×a horizontal length S3 as a transfer space necessary for transfer from the vehicle 4C to the vehicle 4D on the basis of each of the sizes of the vehicle 4C and the vehicle 4D.

As illustrated in FIG. 6C, in a case where a transfer mode is defined in which a vehicle 4A as a transfer source is stopped near vehicles 4E, 4F, and 4G as transfer destinations, the management control unit 223 determines an interval M3 between the vehicle 4A and the vehicles 4E, 4F, and 4G on the basis of the mobile body attribute information. Next, the management control unit 223 calculates a space determined by a vertical length S4×a horizontal length S5 as a transfer space necessary for transfer from the vehicle 4A to the vehicles 4E, 4F, and 4G on the basis of each of the sizes of the vehicles 4A, 4E, 4F, and 4G.

As illustrated in FIG. 6D, in a case where a transfer mode is defined in which a user is moved from a vehicle 4A to a station C, a rental cycle office D, and a PMV waiting place E, the management control unit 223 determines a position where a distance between the vehicle 4A and each of the station C, the rental cycle office D, and the PMV waiting place E is the shortest on the basis of the static information included in the target area information and the mobile body attribute information. Next, the management control unit 223 calculates a space determined by a vertical length S1×a horizontal length S6 as a transfer space necessary for stopping the vehicle 4A at the position on the basis of the size of the vehicle 4A.

As illustrated in FIG. 6E, in a case where a plurality of users are about to get on a vehicle 4A, the management control unit 223 determines a waiting space in which there is no flow of people and a waiting line has a shortest length S9 on the basis of the static information included in the target area information, the mobile body attribute information, and the user attribute information.

Next, the management control unit 223 calculates a space determined by a vertical length S7×a horizontal length S8 as a space necessary for stopping the vehicle 4A near the waiting space on the basis of the size of the vehicle 4A.

The management control unit 223 changes a space arrangement in the target area A on the basis of the calculated transfer space requirement (step ST7A). For example, the management control unit 223 selects a space meeting the transfer space requirement from among spaces that have not been reserved in the space reservation information, and allocates the selected space as a new transfer space. Here, a space that does not interfere with an existing space set in the space reservation information is set as a new transfer space.

FIG. 7 is a diagram illustrating a dynamic map of the target area A reflecting use spaces of vehicles 4A and 4B. In the dynamic map illustrated in FIG. 7, the management control unit 223 reflects a space in which an interval between the vehicle 4A and the vehicle 4B is M1 and which has a size of a vertical length S1×a horizontal length S2 as a transfer space necessary for transfer from the vehicle 4A to the vehicle 4B. The output control unit 224 outputs mobile body control information for moving a mobile body in accordance with the dynamic map illustrated in FIG. 7 to the vehicle 4A and the vehicle 4B. As a result, transfer from the vehicle 4A to the vehicle 4B is performed in the transfer space of the dynamic map illustrated in FIG. 7.

If it is determined that it is not necessary to add the transfer space to the space reservation of the target area A (step ST4A; NO), the determination unit 222 determines whether or not it is necessary to change a space arrangement in the space reservation information (step ST10A). That is, the determination unit 222 determines whether or not the target area A has changed to a situation where the transfer space should be added to the space reservation. If it is determined that it is not necessary to change the space arrangement in the target area A (step ST10A; NO), a series of processing in FIG. 5 ends.

If it is determined that it is necessary to change the space arrangement in the target area A (step ST10A; YES), the management control unit 223 proceeds to step ST7A, and updates the use reservation of the space indicated by the space reservation information on the basis of the transfer mode determined by the determination unit 222. For example, the management control unit 223 reallocates the reserved space set in the space reservation information, including a new transfer space. As a result, the information processing device 2 can provide a use space of the mobile body 4 in consideration of convenience of a user.

The management control unit 223 updates an area where entry of the mobile body 4 is monitored on the basis of the use mode of the target area determined by the determination unit 222 (step ST8A). It is necessary to monitor entry of the unnecessary mobile body 4 into a new allocated space with the new allocation of a space in the space reservation information. Therefore, the management control unit 223 sets a management area for the new allocated space.

The management control unit 223 updates a use reservation of the space indicated by the space reservation information with the contents determined in steps ST7A and ST8A (step ST9A). Since the use reservation of the space is updated on the basis of the use mode determined by the determination unit 222, the information processing device 2 can provide a use space of the mobile body 4 in consideration of convenience of a user.

Next, processing of controlling a vehicle on the basis of the space reservation information will be described.

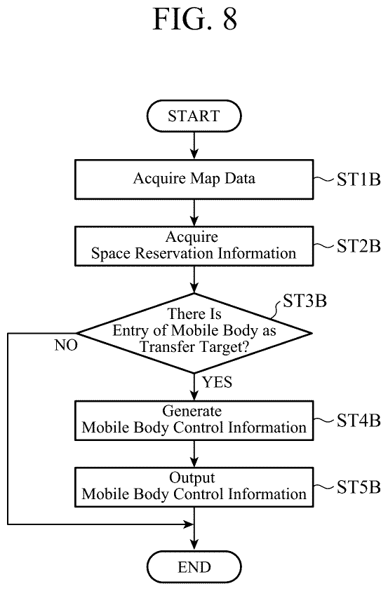

FIG. 8 is a flowchart illustrating vehicle 4A control processing based on the space reservation information. As illustrated in FIG. 6D, the determination unit 222 defines a transfer mode in which a user is moved from a vehicle 4A to a station C, a rental cycle office D, and a PMV waiting place E. Furthermore, it is assumed that the management control unit 223 updates the space reservation information in a transfer space in which a distance between the vehicle 4A and each of the station C, the rental cycle office D, and the PMV waiting place E is the shortest.

The management control unit 223 acquires map data from the storage unit 23 (step ST1B), and acquires space reservation information of the user in the target area A from the storage unit 23 (step ST2B). Note that the case where the management control unit 223 acquires the map data and the space reservation information in this order has been described, but this order may be changed, or these may be acquired simultaneously.

The determination unit 222 determines whether or not the vehicle 4A as a transfer target has entered the target area A on the basis of the target area information (step ST3B). If it is determined that the vehicle 4A has not entered the target area A (step ST3B; NO), the processing of FIG. 8 is ended.

If it is determined that the vehicle 4A has entered the target area A (step ST3B; YES), the determination unit 222 notifies the management control unit 223 of the fact. When receiving the notification from the determination unit 222, the management control unit 223 outputs, to the output control unit 224, the space reservation information and a dynamic map describing the transfer space in which a distance between the vehicle 4A and each of the station C, the rental cycle office D, and the PMV waiting place E is the shortest.

The output control unit 224 generates mobile body control information for moving the vehicle 4A to the transfer space set in the space reservation information (step ST4B). Subsequently, the output control unit 224 outputs the mobile body control information to the vehicle 4A via the network 7 using the communication unit 21 (step ST5B). As a result, the vehicle 4A moves to the transfer space in which a distance between the vehicle 4A and each of the station C, the rental cycle office D, and the PMV waiting place E is the shortest.

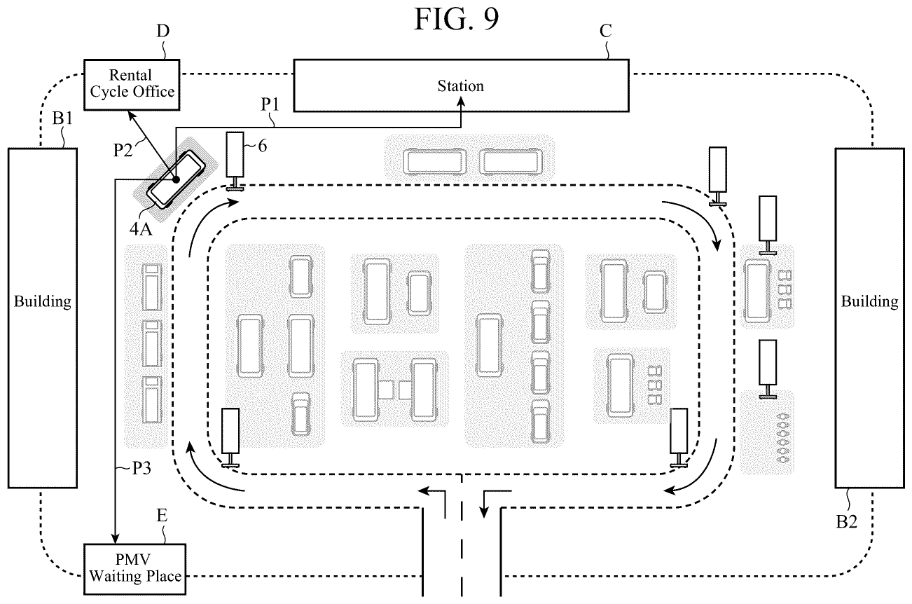

FIG. 9 is a diagram illustrating a dynamic map of the target area A when an example (1) of vehicle control processing is performed. The dynamic map illustrated in FIG. 9 describes a transfer space in which a user moves from the vehicle 4A to each of a station C, a rental cycle office D, and a PMV waiting place E. In the transfer space where the vehicle 4A stops, each of a route P1 from the vehicle 4A to the station C, a route P2 from the vehicle 4A to the rental cycle office D, and a route P3 from the vehicle 4A to the PMV waiting place E is the shortest distance. As a result, a distance necessary for the user who has got off the vehicle 4A to move by walking before the user reaches a target point is the shortest.

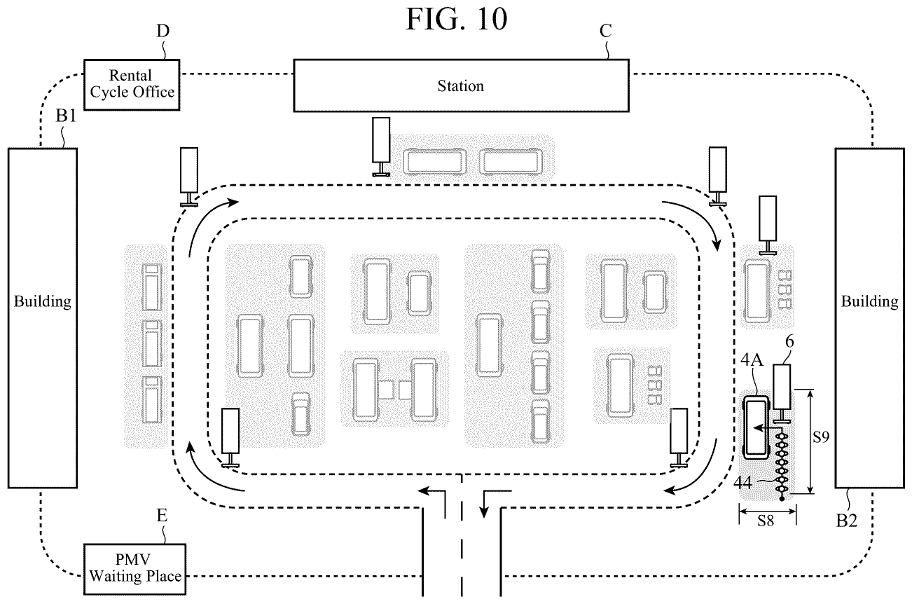

FIG. 10 is a diagram illustrating a dynamic map of the target area A when an example (2) of vehicle control processing is performed. The dynamic map illustrated in FIG. 10 describes a waiting space of a user who is about to get on the vehicle 4A. In the transfer space where the vehicle 4A stops, a length S9 of a waiting line of users who are about to get on the vehicle 4A is the shortest. As a result, a waiting time of a user who is going to get on the vehicle 4A is the shortest.

Next, processing of outputting display control information on the basis of the space reservation information will be described.

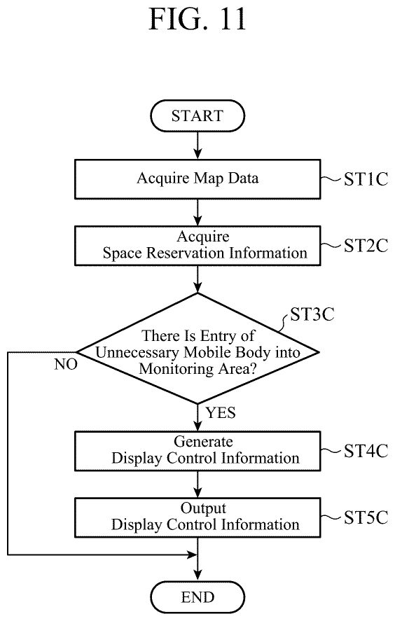

FIG. 11 is a flowchart illustrating display processing based on the space reservation information.

The management control unit 223 acquires map data from the storage unit 23 (step ST1C), and acquires space reservation information of a user in the target area A from the storage unit 23 (step ST2C). Note that the case where the management control unit 223 acquires the map data and the space reservation information in this order has been described, but this order may be changed, or these may be acquired simultaneously.

The determination unit 222 determines whether or not there is entry of the unnecessary mobile body 4 into the transfer space on the basis of the target area information (step ST3C). If it is determined that there is no entry of the unnecessary mobile body 4 (step ST3C; NO), the processing of FIG. 9 is ended.

On the other hand, if it is determined that the unnecessary mobile body 4 has entered the transfer space (step ST3C; YES), the determination unit 222 notifies the management control unit 223 of the fact.

When receiving the notification from determination unit 222, the management control unit 223 outputs, to the output control unit 224, space reservation information in which a management area in which entry of the unnecessary mobile body 4 into the transfer space is monitored is set.

The output control unit 224 generates display control information indicating the management area set in the space reservation information (step ST4C). Subsequently, the output control unit 224 outputs the display control information to the mobile body 4 or the display 6 via the network 7 using the communication unit 21 (step ST5C). As a result, entry of the unnecessary mobile body 4 into the transfer space can be prevented.

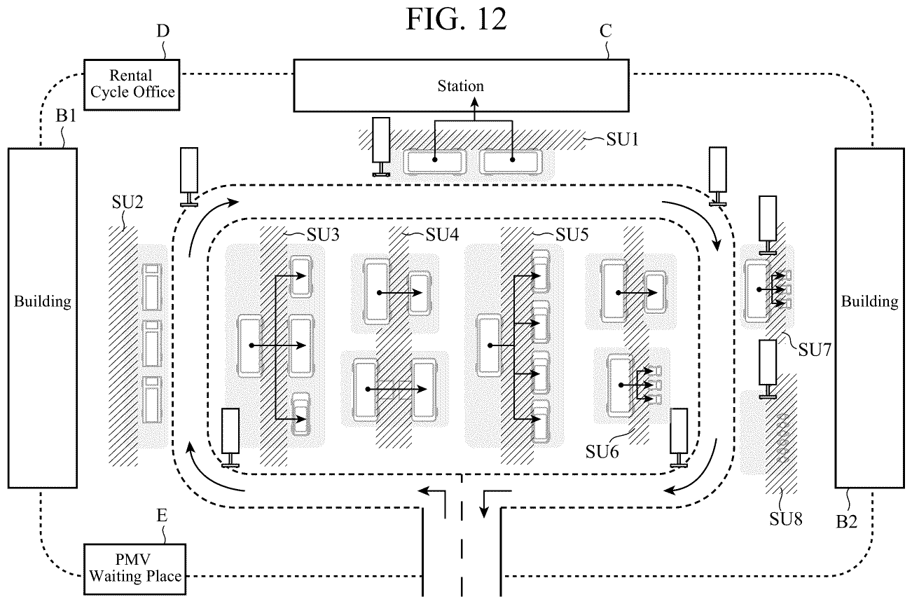

FIG. 12 is a diagram illustrating a dynamic map of the target area A reflecting monitoring areas SU1 to SU8 in which entry of a vehicle into a reserved space is monitored. In the dynamic map illustrated in FIG. 12, the management areas SU1 to SU8 in which entry of the unnecessary mobile body 4 into a transfer space is monitored are described. For example, the dynamic map is displayed for an in-vehicle display of a vehicle that is about to enter the management areas SU1 to SU8. A driver of the vehicle can avoid entry of the vehicle into the transfer space by visually recognizing the dynamic map.

The display control information may be at least one of information indicating call for attention to the mobile body 4, information for prompting a route change of the mobile body 4, and information indicating call for attention to a user.

By referring to the display based on the display control information, it is possible to call attention of an occupant of the mobile body 4 who has not made a transfer reservation in such a manner that the mobile body 4 does not enter the transfer space. In addition, by referring to the display based on the display control information, it is possible to cause the occupant of the mobile body 4 who has not made a transfer reservation to change a movement route of the mobile body 4 in such a manner that the mobile body 4 does not enter the transfer space. Furthermore, by referring to the display based on the display control information, it is possible to call attention of a user who has not made a transfer reservation in such a manner that the user does not enter the transfer space.

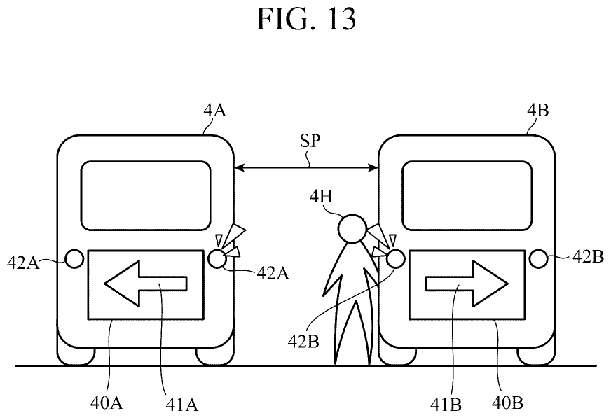

FIG. 13 is a diagram illustrating an example (1) of a display mode in which entry of a vehicle into a reserved space is prohibited. A display mode is illustrated in which attention is called in such a manner that an unnecessary vehicle does not enter a transfer space from the vehicle 4A to the vehicle 4B. In the transfer space, the vehicle 4A as a transfer source is stopped alongside the vehicle 4B as a transfer destination. In an interval SP between the vehicle 4A and the vehicle 4B, a user 4H performs transfer to the vehicle 4B.

The output control unit 224 generates, for example, display control information for causing an in-vehicle display 40A included in the vehicle 4A and an in-vehicle display 40B included in the vehicle 4B to display display images 41A and 41B for calling attention to entry into a space between the vehicle 4A and the vehicle 4B. The in-vehicle display 40A displays the display image 41A indicating an arrow that prompts traveling in a direction away from a space between the vehicle 4A and the vehicle 4B in accordance with the display control information. Similarly, the in-vehicle display 40B displays the display image 41B indicating an arrow that prompts traveling in a direction away from a space between the vehicle 4A and the vehicle 4B in accordance with the display control information. The in-vehicle displays 40A and 40B perform display for the outside of the vehicles.

A driver of a vehicle or a pedestrian traveling in the target area A is called attention to entry into a space between the vehicle 4A and the vehicle 4B by visually recognizing the display image 41A or the display image 41B.

In addition, as illustrated in FIG. 13, the output control unit 224 may output, to the vehicle 4A and the vehicle 4B, mobile body control information for turning on a blinker 42A included in the vehicle 4A and turning on a blinker 42B included in the vehicle 4B in order to call attention to entry into a space between the vehicle 4A and the vehicle 4B. As a result, the blinker 42A on the vehicle 4B side is turned on in the vehicle 4A, the blinker 42B on the vehicle 4A side is turned on in the vehicle 4B, and therefore attention of a driver of a vehicle or a pedestrian traveling in the target area A is called to entry into a space between the vehicle 4A and the vehicle 4B.

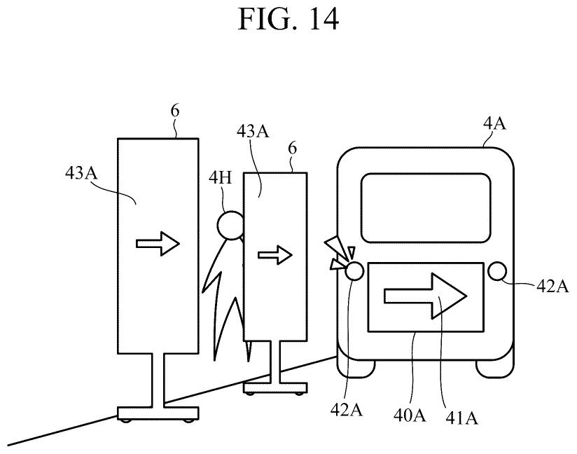

FIG. 14 is a diagram illustrating an example (2) of a display mode in which entry of a vehicle into a reserved space is prohibited. A display mode is illustrated in which attention is called in such a manner that an unnecessary vehicle does not enter a transfer space in which a user 4H gets on a vehicle 4A. The transfer space is allocated to a roadside of a road space, and the user 4H gets on the vehicle 4A from a waiting space along the road space. In addition, the transfer space needs to be monitored in such a manner that a vehicle does not enter the rear of the stopped vehicle 4A.

For example, the output control unit 224 generates display control information for causing the display 6, which is a roadside display disposed along the road space, to display a display image 43A.

Furthermore, the output control unit 224 generates display control information for causing the in-vehicle display 40A included in the vehicle 4A to display the display image 41A.

The display image 41A and the display image 43A call attention to entry of another vehicle to the rear of the vehicle 4A, and indicate arrows that prompt traveling in a direction away from the vehicle 4A.

A driver of a vehicle traveling or a pedestrian in the target area A is called attention to entry to the rear of the vehicle 4A is called by visually recognizing the display image 41A or the display image 43A.

In addition, as illustrated in FIG. 14, the output control unit 224 may output, to the vehicle 4A, mobile body control information for turning on a blinker 42A included in the vehicle 4A in order to call attention to entry to the rear of the vehicle 4A. In the vehicle 4A, the blinker 42A on the waiting space side is turned on. By a driver of a vehicle or a pedestrian visually recognizing that the blinker 42A is turned on, attention to entry to the rear of the vehicle 4A is called.

Next, processing of changing space allocation on the basis of a use frequency of a target area will be described.

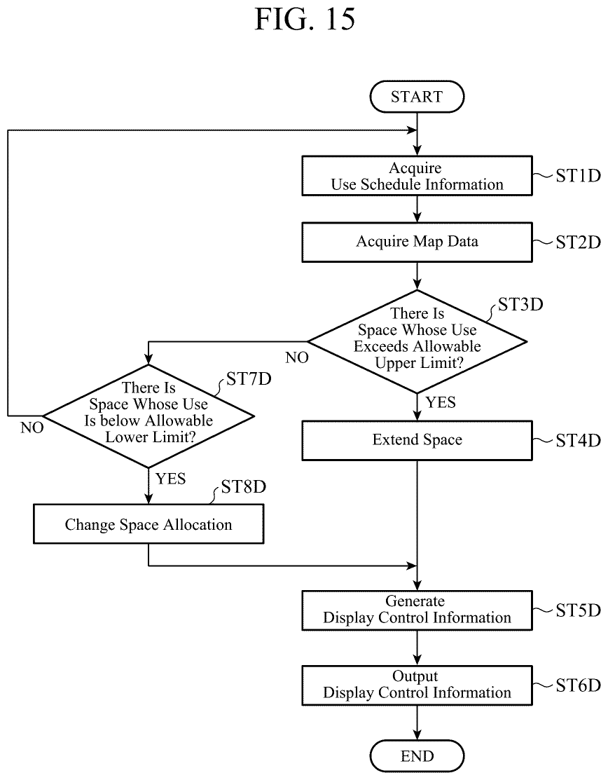

FIG. 15 is a flowchart illustrating space allocation change processing in the target area A.

The information acquisition unit 221 acquires use schedule information from the service server 5 via the network 7 using the communication unit 21 (step ST1D). The information acquisition unit 221 acquires map data from the storage unit 23 (step ST2D). Note that the case where the information acquisition unit 221 acquires the use schedule information and the map data in this order has been described, but this order may be changed, or these may be acquired simultaneously.

The determination unit 222 determines whether or not there is a space whose use exceeds an allowable upper limit in the target area A on the basis of the use schedule information (step ST3D). The allowable upper limit is a threshold indicating a minimum flow of people for which space allocation should be changed. If the determination unit 222 determines that there is a space whose use exceeds an allowable upper limit (step ST3D; YES), the determination unit 222 notifies the management control unit 223 of the fact. When receiving the notification from the determination unit 222, the management control unit 223 extends the space whose use exceeds the allowable upper limit (step ST4D). For example, in a case where a part of a space adjacent to the space whose use exceeds the allowable upper limit is not reserved for use, the management control unit 223 allocates the part that is not reserved for use to the space whose use exceeds the allowable upper limit.

The output control unit 224 generates display control information for displaying a dynamic map including the extended space (step ST5D). Next, the output control unit 224 outputs the display control information to the mobile body 4 or the display 6 via the network 7 using the communication unit 21 (step ST6D). As a result, the dynamic map including the extended space is displayed on the display.

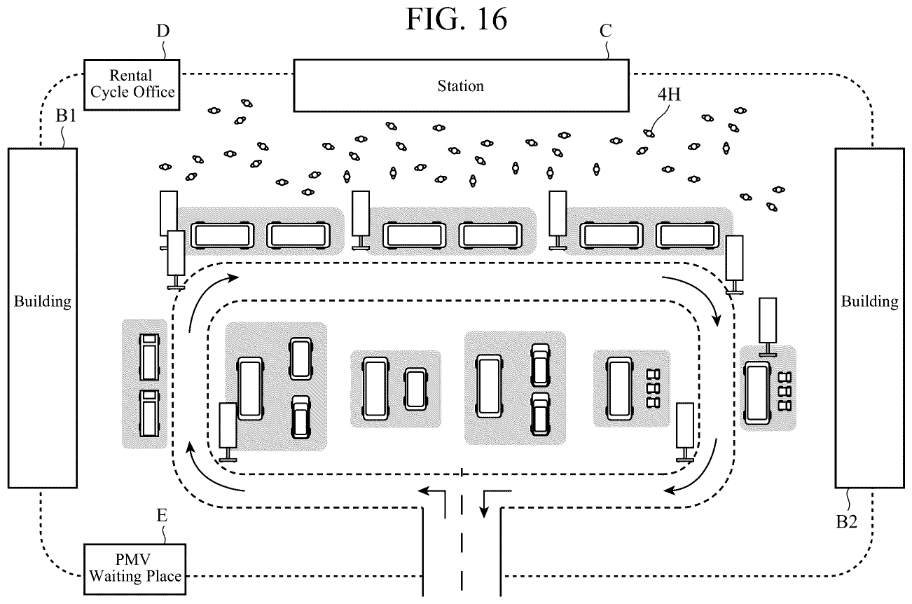

FIG. 16 is a diagram illustrating a dynamic map of the target area A, and illustrates a dynamic map including an extended space. In FIG. 16, a flow of people in a transfer space in front of a station exceeds an allowable upper limit in a commuting time period, and therefore a part of a space in a rotary adjacent to this space is allocated to the transfer space. As a result, congestion of the transfer space can be alleviated.

If the determination unit 222 determines that there is no space whose use exceeds an allowable upper limit (step ST3D; NO), the determination unit 222 determines whether or not there is a space whose use is below an allowable lower limit in the target area A (step ST7D). The allowable lower limit is a threshold indicating a maximum flow of people for which space allocation should be changed. If there is no space whose use is below an allowable lower limit (step ST7D; NO), the processing returns to step ST1D again, and a series of processing in FIG. 15 is repeated.

If there is a space whose use is below an allowable lower limit (step ST7D; YES), the determination unit 222 notifies the management control unit 223 of the fact. When receiving the notification from the determination unit 222, the management control unit 223 changes the allocation of the space whose use is below the allowable lower limit (step ST8D). For example, the management control unit 223 allocates a part of the space whose use is below the allowable lower limit to a space for another use.

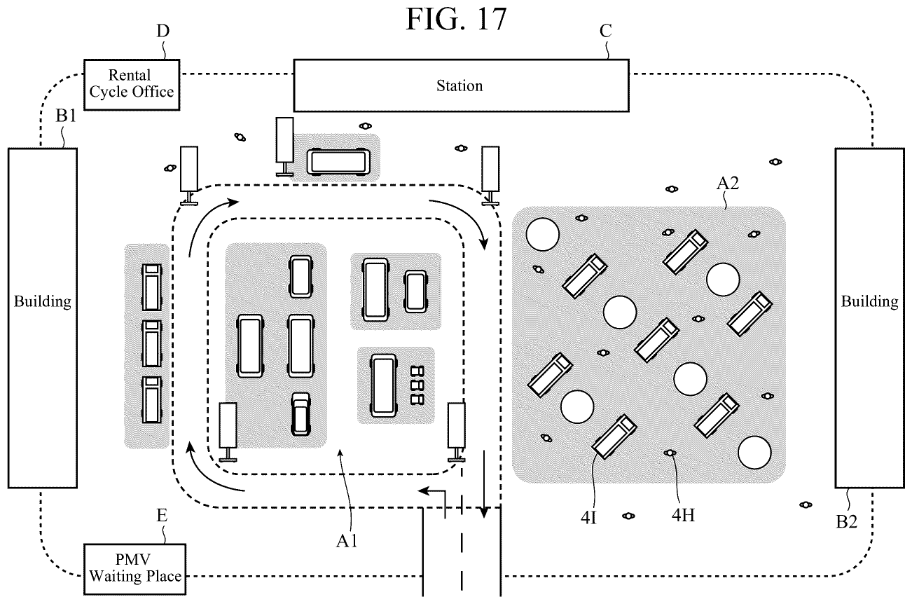

FIG. 17 is a diagram illustrating a dynamic map of the target area A in which the space allocation has been changed, and illustrates a dynamic map including a space in which the allocation has been changed. In FIG. 17, a flow of people in a transfer space in a rotary is below an allowable lower limit, and therefore a part of the transfer space is allocated to an eating and drinking event space used by a mobile selling vehicle 4I which is a kitchen car. As a result, the space of the target area A can be effectively utilized.

As described above, the information processing device 2 according to the first embodiment includes: the information acquisition unit 221 that acquires target area information, use schedule information, and space reservation information; the determination unit 222 that determines a use mode depending on convenience of a user on the basis of the target area information and the use schedule information; and the management control unit 223 that updates the space reservation information on the basis of the determined use mode. When a use mode depending on convenience of the user is determined, the space reservation information is updated, depending on the use mode, and therefore the information processing device 2 can provide a use space of the mobile body 4 in consideration of the convenience of the user.

The information processing device 2 according to the first embodiment includes the output control unit 224 that generates mobile body control information for controlling movement of a mobile body in a target area on the basis of the updated space reservation information, and outputs the generated mobile body control information to the mobile body. As a result, the mobile body 4 can be moved to the use space on the basis of the updated space reservation information.

In the information processing device 2 according to the first embodiment, the mobile body control information includes information for moving the mobile body 4 along a route to a space where a user gets on and off the mobile body 4 and control information of equipment used when the user gets on and off the mobile body 4. As a result, the getting-on and getting-off equipment can be used when the user gets on and off the mobile body 4.

The information processing device 2 according to the first embodiment includes the output control unit 224 that generates display control information for displaying movement of the mobile body 4 in a target area on the basis of the updated space reservation information, and outputs the generated display control information to the display 6. As a result, the use space based on the updated space reservation information can be presented to the mobile body 4 side.

In the information processing device 2 according to the first embodiment, the display control information is information for causing the display 6 to display at least one of information indicating call for attention to the mobile body 4, information for prompting a route change of the mobile body 4, and information indicating call for attention to a user.

By referring to the display based on the display control information, it is possible to call attention of an occupant of the mobile body 4 who has not made a transfer reservation in such a manner that the mobile body 4 does not enter the transfer space. In addition, by referring to the display based on the display control information, it is possible to cause the occupant of the mobile body 4 who has not made a transfer reservation to change a movement route of the mobile body 4 in such a manner that the mobile body 4 does not enter the transfer space. Furthermore, by referring to the display based on the display control information, it is possible to call attention of a user who has not made a transfer reservation in such a manner that the user does not enter the transfer space.

In the information processing device 2 according to the first embodiment, the target area information is information including static information indicating a static situation of a target area, semi-static information indicating a future situation of the target area, semi-dynamic information indicating a situation of the target area in a nearer future than the semi-static information, and dynamic information indicating a dynamic situation of the target area. As a result, the information processing device 2 can recognize current and future states of the target area on the basis of the static information, the semi-static information, the semi-dynamic information, and the dynamic information regarding the target area, and can perform space management depending on the current and future states of the target area.

In the information processing device 2 according to the first embodiment, the use schedule information includes use content information indicating a use content of a mobile body, mobile body attribute information indicating an attribute of the mobile body to be used, and user attribute information indicating an attribute of a user who uses the mobile body. The information processing device 2 can recognize an attribute of the mobile body 4 and a state of a user at the time of using the mobile body 4 in addition to a specific method in which the user uses the mobile body 4 by using the use content information, the mobile body attribute information, and the user attribute information. As a result, the information processing device 2 can determine a use mode of the mobile body 4 depending on convenience of the user, and the space management system 1 can perform space management depending on the determined use mode.

In the information processing device 2 according to the first embodiment, the space reservation information is information indicating an hourly use reservation of at least one of a road space where the mobile body 4 travels, a use space where a user uses the mobile body 4, an event space, and a sidewalk space where a pedestrian moves. By using the space reservation information, the information processing device 2 can allocate a space of the target area to various uses in addition to use of the mobile body 4 by the user.

In the information processing device 2 according to the first embodiment, the management control unit 223 generates a dynamic map reflecting a use mode depending on convenience of a user. By referring to the dynamic map, it is possible to recognize a use space in which the user uses the mobile body 4.

In the information processing device 2 according to the first embodiment, the determination unit 222 determines a mode in which a user gets on and off the mobile body 4. As a result, the information processing device 2 can provide a getting-on and getting-off space of the mobile body 4 in consideration of convenience of the user.

In the information processing device 2 according to the first embodiment, the determination unit 222 determines a getting-on and getting-off space in which a user gets on and off the mobile body 4, determines whether or not equipment included in the mobile body 4 is used when the user gets on and off the mobile body 4, and determines a waiting space of the user who gets on the mobile body 4. As a result, the information processing device 2 can provide a getting-on and getting-off space of the mobile body 4, use of getting-on and getting-off equipment, and a waiting space of a user in consideration of convenience of the user.

In the information processing device 2 according to the first embodiment, the management control unit 223 updates a use reservation of a space indicated by the space reservation information on the basis of a use mode determined by the determination unit 222. As a result, the information processing device 2 can provide a use space of the mobile body 4 in consideration of convenience of a user.

In the information processing device 2 according to the first embodiment, the management control unit 223 updates an area where entry of the mobile body 4 is monitored on the basis of the use mode of the target area determined by the determination unit 222. As a result, the information processing device 2 can set a management area for a new allocated space.

In the information processing device 2 according to the first embodiment, the management control unit 223 changes spaces for various uses in a target area on the basis of a use situation of the target area. As a result, a space in the target area can be effectively utilized.

The space management system 1 according to the first embodiment includes the information processing device 2 and the sensor device 3. Space reservation information is updated depending on a use mode of a target area corresponding to a use schedule of a user, and therefore the space management system 1 can provide a use space of the mobile body 4 in consideration of convenience of the user.

In the space management system 1 according to the first embodiment, the sensor device 3 includes the pole 3b erected in a target area and the sensor unit 3a that is disposed at a top portion of the pole 3b and detects the mobile body 4 in the target area. The sensor device 3 can detect an object from a position where the target area is overlooked. As a result, the space management system 1 can recognize a state of an object present in the entire target area on the basis of the detection information obtained by overlooking the target area.

The space management system 1 according to the first embodiment includes a roadside display disposed on a roadside in a target area and an in-vehicle display that performs display for the outside of the mobile body 4. At least one of the roadside display and the in-vehicle display displays at least one of information indicating call for attention to the mobile body 4, information for prompting a route change of the mobile body 4, and information indicating call for attention to a user on the basis of display control information input from the information processing device 2.

By referring to the display based on the display control information, it is possible to call attention of an occupant of the mobile body 4 who has not made a transfer reservation in such a manner that the mobile body 4 does not enter the transfer space. In addition, by referring to the display based on the display control information, it is possible to cause the occupant of the mobile body 4 who has not made a transfer reservation to change a movement route of the mobile body 4 in such a manner that the mobile body 4 does not enter the transfer space. Furthermore, by referring to the display based on the display control information, it is possible to call attention of a user who has not made a transfer reservation in such a manner that the user does not enter the transfer space.

An information processing method according to the first embodiment includes: acquiring, by the information acquisition unit 221, target area information, use schedule information, and space reservation information; determining, by the determination unit 222, a use mode of a target area corresponding to a use schedule of a user indicated by the use schedule information on the basis of the target area information and the use schedule information; and updating, by the management control unit 223, the space reservation information on the basis of the determined use mode of the target area. Since the space reservation information is updated depending on the use mode of the target area corresponding to the use schedule of the user, a use space of the mobile body 4 in consideration of convenience of the user can be provided.

Note that any component in the embodiment can be modified, or any component in the embodiment can be omitted.

### INDUSTRIAL APPLICABILITY

The information processing device according to the present disclosure can be used, for example, for determining a use space of a self-driving vehicle.

### REFERENCE SIGNS LIST

1: space management system, 2: information processing device, 3: sensor device, 3a: sensor unit, 3b: pole, 3c: detection range, 4: mobile body, 4A to 4G: vehicle, 4H: pedestrian, 4I: mobile selling vehicle, 5: service server, 6: display, 7: network, 21: communication unit, 22: calculation unit, 23: storage unit, 40A, 40B: in-vehicle display, 41A, 41B, 43A: display image, 42A, 42B: blinker, 100: communication interface, 101: input and output interface, 102: processor, 103: memory, 221: information acquisition unit, 222: determination unit, 223: management control unit, 224: output control unit

1. An information processing device comprising:
processing circuitry configured to
acquire target area information indicating a situation of a target area, use schedule information indicating a use schedule of a mobile body by a user in the target area, and space reservation information indicating a use reservation of a space in the target area;
determine a use mode of the space for the mobile body depending on convenience of the user in the target area on a basis of the target area information and the use schedule information; and
update the space reservation information on a basis of the determined use mode;
determine whether or not it is necessary to newly add a space where the user transfers from the mobile body to another mobile body in the target area, using the use schedule information and the space reservation information; and
when determining that it is necessary to newly add the space, determine a transfer mode of the mobile body depending on the convenience of the user, define the determined transfer mode as a new use mode, and calculate a space requirement necessary for the transfer mode.

2. An information processing device comprising:
processing circuitry configured to
acquire target area information indicating a situation of a target area, use schedule information indicating a use schedule of a mobile body by a user in the target area, and space reservation information indicating a use reservation of a space in the target area;
determine a use mode of the space for the mobile body depending on convenience of the user in the target area on a basis of the target area information and the use schedule information;
update the space reservation information on a basis of the determined use mode;
determine whether or not the number of users, who use the space of which the reservations have been made via the space reservation information in a predetermined time zone, is equal to or higher than a predetermined threshold value;
update the space reservation information in which part of an adjacent space is allocated to the space when it is determined that the number of users who use the space is equal to or higher than the predetermined threshold value; and
update the space reservation information in which the part of the space is allocated to the adjacent space when it is determined that the number of users who use the space is less than the predetermined threshold value and generate a dynamic map including the space in which the allocation has been changed.

3. The information processing device according to claim 1, wherein
the processing circuitry is further configured to generate mobile body control information for controlling movement of the mobile body in the target area on a basis of the updated space reservation information, and to output the generated mobile body control information to the mobile body.

4. The information processing device according to claim 3, wherein
the mobile body control information includes information for moving the mobile body along a route to a space where the user gets on and off the mobile body and control information of equipment used when the user gets on and off the mobile body.

5. The information processing device according to claim 1, wherein
the processing circuitry is further configured to
generate display control information for displaying movement of the mobile body or a pedestrian in the target area on a basis of the updated space reservation information; and
output the generated display control information to a display disposed in the target area and a display mounted on the mobile body in the target area.

6. The information processing device according to claim 5, wherein
the display control information is information for causing the display to display at least one of information indicating call for attention to the mobile body, information for prompting a route change of the mobile body, and information indicating call for attention to the user.

7. The information processing device according to claim 1, wherein
the target area information is information including static information indicating a static situation of the target area, semi-static information indicating a future situation of the target area, semi-dynamic information indicating a situation of the target area in a nearer future than the semi-static information, and dynamic information indicating a dynamic situation of the target area.

8. The information processing device according to claim 7, wherein
the use schedule information includes use content information indicating a use content of the mobile body, mobile body attribute information indicating an attribute of the mobile body to be used, and user attribute information indicating an attribute of the user who uses the mobile body.

9. The information processing device according to claim 7, wherein
the space reservation information is information indicating an hourly use reservation of at least one of a road space where the mobile body travels, a use space where the user uses the mobile body, an event space, and a sidewalk space where a pedestrian moves.

10. The information processing device according to claim 5, wherein
the processing circuitry is further configured to generate a dynamic map reflecting the use mode of the space for the mobile body depending on the convenience of the user in the target area.

11. The information processing device according to claim 5, wherein
the processing circuitry is further configured to
determine a mode in which the user gets on and off the mobile body;
update the space reservation information on a basis of the determined getting-on/off mode; and
generate mobile body control information that includes control information of equipment included in the mobile body and used when the user gets on and off the mobile body and information for moving the mobile body or a pedestrian along a route to a use space, and outputs the mobile body control information to the mobile body.

12. The information processing device according to claim 1, wherein
the processing circuitry is further configured to update a use reservation of a space indicated by the space reservation information on a basis of the determined use mode.

13. The information processing device according to claim 5, wherein
the processing circuitry is further configured to
set a monitoring area in which entry of another mobile body into a reserved space, in which the mobile body is permitted to be used based on the updated space reservation information, is monitored, and
output the display control information, which brings a warning display that alerts said another mobile body or the pedestrian not to enter the monitoring area, to a display mounted in said another mobile body entering the monitoring area or a display provided the monitoring area when said another mobile body or a pedestrian enters the monitoring area.

14. A space management system comprising:
the information processing device according to claim 1; and
a sensor device to detect a situation of the target area and output the target area information.

15. The space management system according to claim 14, wherein
the sensor device includes a pole erected in the target area and a sensor disposed at a top portion of the pole, to detect the mobile body in the target area.

16. The space management system according to claim 14, further comprising
a roadside display disposed on a roadside in the target area and an in-vehicle display to perform display for an outside of the mobile body, wherein
at least one of the roadside display and the in-vehicle display displays at least one of information indicating call for attention to the mobile body, information for prompting a route change of the mobile body, and information indicating call for attention to a user on a basis of the display control information input from the information processing device.

17. An information processing method performed with an information processing device, the method comprising:
acquiring target area information indicating a situation of a target area, use schedule information indicating a use schedule of a mobile body by a user in the target area, and space reservation information indicating a use reservation of a space in the target area;
determining a use mode of the space for the mobile body depending on convenience of the user in the target area on a basis of the target area information and the use schedule information;
updating the space reservation information on a basis of the determined use mode;
determining whether or not it is necessary to newly add a space where the user transfers from the mobile body to another mobile body in the target area, using the use schedule information and the space reservation information; and
determining, when it is determined that it is necessary to newly add the space, a transfer mode of the mobile body depending on the convenience of the user, defining the determined transfer mode as a new use mode, and calculating a space requirement necessary for the transfer mode.

18. An information processing method performed with an information processing device, the method comprising:
acquiring target area information indicating a situation of a target area, use schedule information indicating a use schedule of a mobile body by a user in the target area, and space reservation information indicating a use reservation of a space in the target area;
determining a use mode of the space for the mobile body depending on convenience of the user in the target area on a basis of the target area information and the use schedule information;
updating the space reservation information on a basis of the determined use mode;
determining whether or not the number of users, who use the space of which the reservations have been made via the space reservation information in a predetermined time zone, is equal to or higher than a predetermined threshold value;
updating the space reservation information in which part of an adjacent space is allocated to the space when it is determined that the number of users who use the space is equal to or higher than the predetermined threshold value;
updating the space reservation information in which the part of the space is allocated to the adjacent space when it is determined that the number of users who use the space is less than the predetermined threshold value; and
generating a dynamic map including the space in which the allocation has been changed.
